(19) United States
(12) Patent Application Publication
(10) Pub. No.: US 2015/0019194 A1
(43) Pub. Date: Jan. 15, 2015

(54) METHOD FOR AUTOMATIC DESIGN OF AN ELECTRONIC CIRCUIT, CORRESPONDING SYSTEM AND COMPUTER PROGRAM PRODUCT

(71) Applicant: STMICROELECTRONICS S.R.L., Agrate Brianza (IT)

(72) Inventors: Roberto Stella, Como (IT); Alberto Balzarotti, Corbetta (IT)

(73) Assignee: STMICROELECTRONICS S.R.L., Agrate Brianza (IT)

(21) Appl. No.: 14/324,905

(22) Filed: Jul. 7, 2014

(30) Foreign Application Priority Data
Jul. 9, 2013 (IT) TO2013A000574

(51) Int. Cl. G06F 17/50

(52) U.S. Cl. CPC G06F 17/5036
USPC 703/14

(57) ABSTRACT

A method for automatic design of a circuit evaluates thermal effects and electrical effects in a coupled way. A description of the circuit is obtained in terms of a list of simulator nodes or netlist. Using the description, the electrical behavior of the circuit and the thermal behavior of the circuit is simulated. The simulation includes configuring the simulation operation for operating with descriptions of models or sub-circuits of the circuit that are defined using a thermal node. An equivalent current generator is connected to the thermal node to force an equivalent current representing dissipated power. A voltage that is produced on the thermal node is associated with an increase in temperature of the model or sub-circuit with respect to the global temperature.

### PRIORITY CLAIM

This application claims priority from Italian Application for Patent No. TO2013A000574 filed Jul. 9, 2013, the disclosure of which is hereby incorporated by reference.

### TECHNICAL FIELD

The present description relates to techniques for automatic design of an electronic circuit.

### BACKGROUND

In the present description, by “electronic circuit” is meant in general a single integrated circuit or systems of integrated electronic circuits, to be obtained via technologies of machining of integrated circuits on chips that define a substrate for fabrication of the circuit.

Various embodiments may find application in computer apparatuses such as workstations, server computers, and the like.

It is known to carry out, in the design of electronic integrated circuits, simulations of circuits using descriptions of the circuit, for example of the SPICE type, which are able to predict the behavior of the circuit to be manufactured so that it is possible to modify the project and the consequent final product. An integrated circuit comprises a plurality of so-called elementary components, such as, by way of example, bipolar transistors, MOS transistors, high-voltage MOS transistors, JFETs, resistors, and capacitors. These elementary components are described via an analytical model that is able to describe the dependence of the current and of the charge upon the values of voltage applied to the device and upon the temperature.

A circuit simulator, such as the aforementioned SPICE, is able to predict the global behavior of the integrated circuit starting from the models adopted for each elementary component, taking into consideration the effect of the combination of the aforesaid models in the circuit.

In many integrated circuits, especially those used for so-called “smart power applications”, an elementary component can dissipate large amounts of power. This determines an increase in its temperature, i.e., a self-heating, and/or an increase of the local temperature of an elementary component that is in its proximity, i.e., mutual heating. It is known how the electrical parameters of a device markedly depend upon the temperature. Consequently, the effects of heating can affect to a very considerable extent the behavior both of the elementary components and of the overall integrated circuit. It is possible to determine aspects of operation in real circuits that cannot be simulated via known standard methodologies, since these methodologies do not in general take into account the effects of heating.

The effects due to heating may be very critical for the circuit in so far as:
very important electrical parameters, such as current, current gain, transconductance, etc., are affected to a very considerable extent by the local temperature of the component; or instance, in a high-voltage MOS the current may drop by a factor of two on account of self-heating;
increase of the local temperature may lead to destructive failure of a component if the critical temperature is reached;
effects of heating may generate problems of coupling between components that dissipate different amounts of power; for instance, this happens in current mirrors, which are structures that have an extremely wide application in integrated circuits;
effects of heating may determine generation of a temperature gradient in the chip, which can degrade the performance of the couplings and proper operation of the circuit.

In this context, known solutions enable only simulation of the effects of heating in some elementary components via dedicated electrothermal models.

The simulation times that these dedicated electrothermal models require are much longer than those required by standard models since there is no possibility of decoupling the electrical and thermal variables. Consequently, it is not possible with these models to make the simulation of a complex circuit.

Furthermore, many complex circuit components, which are used in smart power circuits, such as for example DMOSs, or the aforementioned HV MOSs, or the LIGBTs, can be described only via a respective sub-circuit that comprises a plurality of elementary components and cannot consequently be simulated via the electrothermal models available. Also in the cases where each elementary component can be described via a compact electrothermal model, the overall sub-circuit can be even so too complex to be analyzed by the electrothermal simulations. In particular, in such sub-circuits the laws of thermal dependence are not the only ones incorporated in the thermal modeling of the elementary components. In actual fact, these laws are used also in the parameters of the model and of the sub-circuit in order to improve the accuracy of the thermal model.

In the context outlined above, there is felt the need to evaluate the thermal interactions between electronic devices of the aforesaid electronic systems and circuits in a chip, overcoming the drawbacks outlined previously.

### SUMMARY

Various embodiments are aimed at meeting the above need.

Various embodiments may also refer to a corresponding system of computers, as well as to a computer program product that can be loaded into the memory of at least one computer and comprises portions of software code that are able to execute the steps of the method when the product is run on at least one computer. As used herein, the reference to such a computer program product is understood as being equivalent to reference to a computer-readable means containing instructions for control of the processing system for co-ordinating implementation of the method according to the invention. Reference to “at least one computer” is evidently intended to highlight the possibility of the present invention being implemented in modular and/or distributed form.

The present invention relates to a method for automatic design of electronic systems and circuits, which comprises steps of simulation of the electronic circuits.

According to one aspect, this method comprises obtaining a description of the electronic circuit in terms of list of nodes or netlist suited to operating with a simulator of electronic circuits, simulating, on the basis of this description, the electrical behavior of the circuit and the thermal behavior of the circuit, providing, in the description of component models or component sub-circuits of said electronic circuit, a thermal node, connecting to the thermal node an equivalent current generator that forces into the thermal node a current representing the power dissipated in the model or sub-circuit, and associating to the voltage that is set up on said thermal node an increase in temperature.

According to a further aspect, it is envisaged to connect to the aforesaid thermal node thermal networks representing mutual heating of the electronic circuit and/or self-heating, and to simulate the thermal effects of these networks on the basis of the current forced into the thermal node.

According to one aspect of the invention, the method comprises providing a specific node, included in the description of the sub-circuit used for simulation of a component and defined as thermal node via a dedicated statement, i.e., an instruction, for example, in a syntax of a SPICE type,

M1 D G S SUB TH MOS

DEFTEMPNODE TH

The simulator calculates the power dissipated by each element present in the sub-circuit and transforms it into an equivalent current generator, that forces current into the thermal node and is connected to a thermal network that makes it possible to take into account the effects of heating, whether self-heating or mutual heating.

### BRIEF DESCRIPTION OF THE DRAWINGS

Various embodiments will now be described, purely by way of non-limiting example, with reference to the annexed drawings, wherein:

FIG. 1 shows schematically an electronic device and an associated thermal network according to the method;

FIG. 2 shows schematically a sub-circuit of an electronic device and an associated thermal network according to the method;

FIG. 3 shows a diagram that represents the results of simulations conducted with the method; and

FIG. 4 illustrates a flowchart representing steps of the method.

### DETAILED DESCRIPTION OF THE DRAWINGS

Illustrated in the ensuing description are various specific details aimed at an in-depth understanding of various examples of embodiment. The embodiments may be provided without one or more of the specific details, or with other methods, components, materials, etc. In other cases, known structures, materials, or operations are not shown or described in detail so that the various aspects of the embodiments will not be obscured. Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in various points of the present description do not necessarily refer to one and the same embodiment. Furthermore, particular conformations, structures, or characteristics may be combined in any adequate way in one or more embodiments.

The references used herein are provided merely for convenience of the reader and hence do not define the sphere of protection or the scope of the embodiments.

By “netlist” or “list of nodes” is here in general meant a description of the connectivity of an electronic project, in particular the design of an electronic circuit. As will be explained more fully in what follows, a thermal netlist represents the equivalent electrical circuit of a thermal model.

The above netlists are in particular of a flat type for an instance-based simulator, in particular a flat SPICE netlist, so as to be compatible with different simulators and fast SPICE simulators.

By “flat netlist” is meant a netlist of a flat design, where only the primitive instances are instantiated.

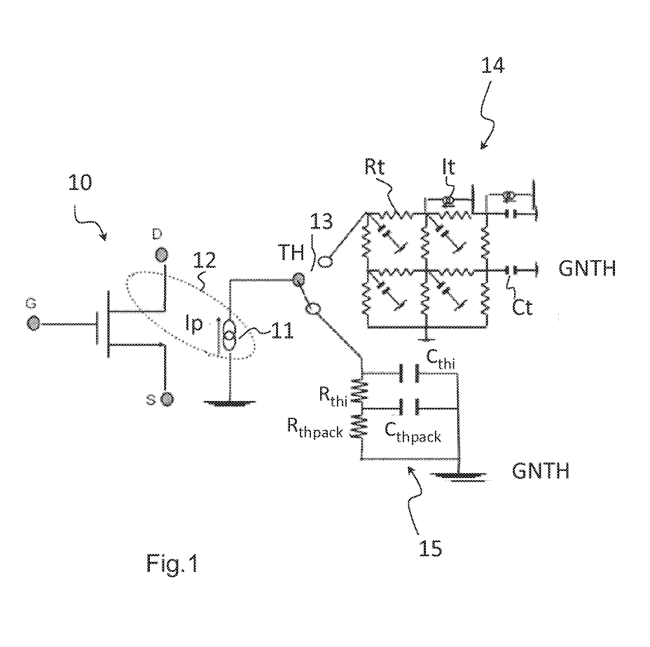

Shown in FIG. 1 is a device 10 of the type that is represented in a simulator such as SPICE via a model, in particular a simple MOS transistor. In order to define an electrothermal coupling 12 and hence be able to carry out the electrothermal simulation, associated to said device 10, on the basis of its operating model, is an equivalent current generator 11 that forces a current Ip equivalent to the power dissipated by the device 10 into the thermal node TH. Connected to the thermal node TH is a switch 13 for switching between a heating thermal network 14, which describes the complex thermal network associated to the entire chip in terms of thermal resistances (conductances) Rt between nodes, with which the circuit is schematically represented, and of thermal capacities CT from the above nodes to the thermal ground, as well as of further equivalent current generators It that represent further devices and structures that dissipate power, and of a self-heating network 15, which once again models, via thermal resistances and capacities, the component itself, i.e., the transistor MOD 10, with respect to self-heating. The above self-heating network 15 comprises a thermal resistance of the device Rₜₕᵢ connected to the input of the network 15, with a thermal resistance of the package of the device R_{thpack} set in series. Corresponding thermal capacities of the device Cₜₕᵢ and of the package C_{thpack} are set in parallel, respectively between the input and a thermal ground GNTH, and from the node set between the thermal resistance of the device Rₜₕᵢ and the thermal resistance of the package of the device R_{thpack}.

Given the device 10, the electrothermal coupling 2 is carried out as described in what follows. The simulator, for example a SPICE-based simulator, is configured for recognizing the voltage at the thermal node V(TH) as an increase of the local temperature of the device 10 with respect to the global junction temperature and updates all the parameters (both the parameters of the device models and the sub-circuit parameters) according to the instantaneous local temperature using the laws of thermal dependence incorporated in the models or written in the sub-circuit or model parameters. For clarity, the so-called junction temperature is defined as the temperature of the chip within the application board; hence, it is a value common to all the devices that are being simulated. In particular, the value of a model or sub-circuit parameter P, for example the electronic mobility or the value of a voltage threshold, is linked to the local temperature of the device by the following relation:

P=f(TEMP)=f(T_{J}+V(TH))

where T_{J} is the global temperature (junction temperature) and f is a generic function that describes the experimental dependence of the parameter P upon the temperature TEMP.

For instance, in the case of the simulation of self-heating in d.c. conditions, the real values of the drain current I_{D} and of increase in local temperature (V(TH)) for the device 10 of FIG. 1 are given by the following equation:

V(TH)=Rₜₕ·Vds·I_{D}(Vgs,Vds,Tj+V(TH))

where Rₜₕ=Rₜₕᵢ R_{thpack}, and Vgs and Vds are the gate-to-source and drain-to-source voltages of the FET 10, respectively.

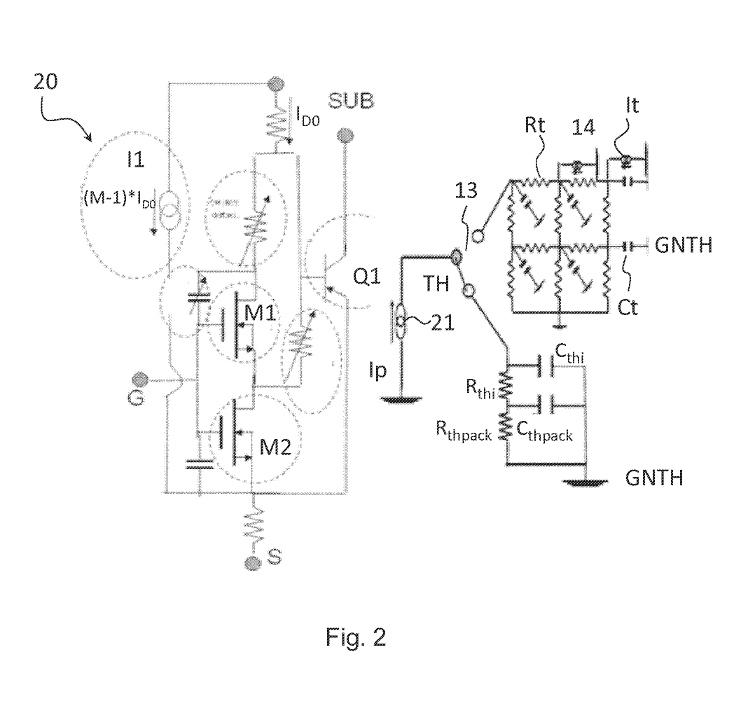

FIG. 2 shows a sub-circuit 20, instead of the model of device 10 of FIG. 1.

The above sub-circuit 20 constitutes the equivalent circuit representation of a MOS device or complex electronic component, which cannot be represented only by a model, as in the case of the MOS transistor 10. Specifically, in FIG. 2, the sub-circuit 20 represents a high-voltage (40 V) MOS transistor and the corresponding parasitic components. There are consequently defined the gate node G, drain node D, source node D, and substrate SUB, and, inside, an equivalent network of resistors, capacitors, a depletion MOS M1, an intrinsic nMOS M2, a current multiplier I1, and an output bipolar transistor Q1.

Also in this case, in order to define an electrothermal coupling and hence be able to carry out the electrothermal simulation, the aforesaid sub-circuit 20, on the basis of its operating model, is associated to an equivalent current generator 21 that forces into the thermal node TH a current equivalent to the power dissipated by the device 10. Connected to the thermal node TH is a switch 13 for switching between the heating thermal network 14 and the self-heating network 15, which once again models, via resistances and thermal capacities, in this case the sub-circuit 20 with respect to self-heating.

For the elements comprised in the aforesaid sub-circuit 20, some additional laws of thermal dependence are used. One law is applied to the parameter of the sub-circuit BV, which is used for modeling a multiplication factor M of the current multiplier I1:

$$M = exp ( {( \frac{V ( D ) - V ( S )}{BV} )}^{MF} )$$

$$BV = BV 0 + BVTC \cdot ( TEMP - 25 ° C . )$$

Furthermore, to increase the accuracy of the sub-model, additional thermal dependences are used for A0 and AGS, which are model parameters of a BSIM, a compact model used for simulation of intrinsic MOSs, such as the MOS M2.

Provided below is an example of the model of the intrinsic NMOS M1 used by the simulator.

.MODEL INTRINSIC NMOS

+LEVEL=53

+VER=3.2

+TNOM=25

+NCH=3.344E+17

A0=(A0*(1+A0T*(TEMP−25)+A0T1*(TEMP−25)̂2)

AGS=(AGS*(1+AGST*(TEMP−25)+AGST1*(TEMP−25)̂2)

The local temperature TEMP of the device is linked to the voltage on the thermal node TH

TEMP=T_{J}+V(TH)

The electrical parameters of the sub-circuit 20 are updated according to the instantaneous local temperature via laws of thermal dependence incorporated in the elementary models (as in the case of the mobility and of the threshold voltage of the intrinsic MOSs) and via additional laws of thermal dependence applied to the sub-circuit or model parameters (BV, A0, AGS).

The method described can be applied to any component used in integrated circuits, such as, by way of non-limiting example, MOSs, HV-MOSs, DMOSs, BJTs, JFETs, LIGBTs, diodes, resistors, capacitors, and inductors.

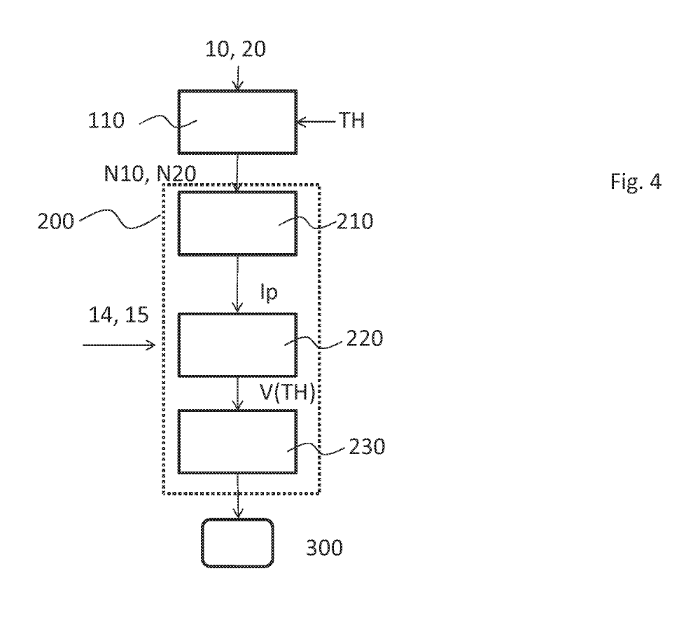

Represented in FIG. 4 is a flowchart that summarizes the main operations of the method.

The method consequently envisages, starting from a device 10 or a sub-circuit 20, obtaining in a step 110 a corresponding description of a netlist type, N10 or N20, suited to operating with a simulator of a SPICE type to obtain a simulation of the electrical and thermal behavior 300. This step 110 comprises obtaining a netlist N10 or N20 in which a thermal node TH is defined via a dedicated statement.

The simulator that carries out the simulation operation, designated as a whole by 200, is configured for operating with the above netlists N10 and N20, which comprise a thermal node TH, and, in particular, after prior detection of the thermal node TH, for carrying out an operation 210 of connection to the aforesaid thermal node TH of an equivalent current generator that forces into the thermal node TH a current Ip equivalent to the power dissipated in the aforesaid model 10 or sub-circuit 20. This envisages in particular connecting to the thermal node TH thermal networks representing mutual heating 14 of the electronic circuit and/or self-heating of the device 15, in order to simulate the thermal effects of these networks 14, 15 using as source the current Ip forced into the thermal node TH.

The simulator that carries out the simulation operation 200 is moreover configured for executing an operation 220 in which it associates to the voltage V(TH) that is set up on the aforesaid thermal node TH an increase in temperature of the model 10 or sub-circuit 20 with respect to the global temperature.

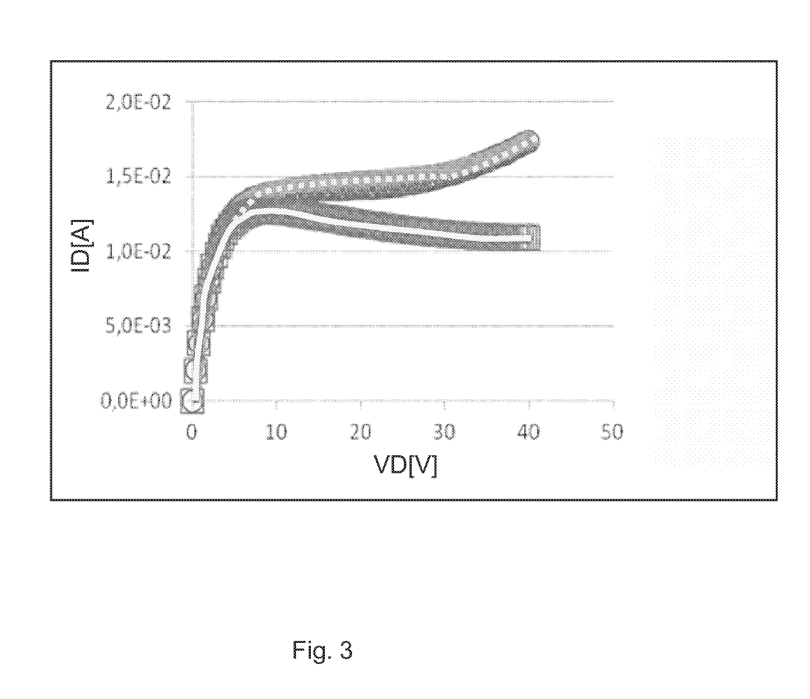

In a step 230, there is then carried out a simulation, which in itself, as is known to a person skilled in the sector, usually operates iteratively to converge towards the solution of the circuit. Consequently, in general it envisages updating also the values of current Ip and voltage V(TH) during the iterations, which produces results of simulation 300 of the behavior of the circuit, for example in terms of currents, as shown in FIG. 3, that take into account thermal effects deriving from the networks 14 and/or 15.

In the case of transient simulations, it is possible to reduce drastically the CPU times, exploiting the fact that the thermal responses are usually much longer than the electrical stimuli. Hence, in the evaluation of the electrical parameters and of the power dissipated, it is assumed that the local temperature does not change in an elementary time interval, i.e., passing from the instant tⱼ to the instant tⱼ₊₁=tⱼ+Δt, and then the variation of temperature calculated at tⱼ+Δt will be used for updating the electrical parameters for the next time interval [tⱼ₊₁, tⱼ₊₁+Δt]. In this way, at each step, or elementary time interval, the thermal variables can be treated as decoupled and the simulation times become comparable to those of standard simulations, i.e., non-electrothermal simulations.

FIG. 3 shows the results of a standard circuit simulator that operates using the method according to the invention. In particular, in FIG. 3, results regarding the sub-circuit 20 of FIG. 2 are shown. FIG. 3 illustrates the output characteristic of the sub-circuit 20 at the maximum gate-to-source voltage Vgs of the device that it represents. The results of the simulation are compared with experimental data.

Using a standard model drawn from measurements conducted by applying very short pulses of gate-to-source voltage (100 ns) in order to prevent onset of self-heating, it is not possible to reproduce via simulation the actual current in d.c. conditions, where the device is markedly affected by self-heating. Instead, by applying the electrothermal simulation, the results of the simulation appear to be in good alignment with the experimental data. Specifically, represented in FIG. 3 is the drain current ID of the device 20 as a function of the drain voltage VD. Represented by the squares is the drain current ID measured experimentally, whilst represented by the circles is the drain current ID measured with application of pulses of gate-to-source voltage of 100 ns; the solid line that follows the squares represents the current ID simulated via the method according to the invention, taking self-heating into account, and the dashed line that follows the circles is the current ID simulated without taking self-heating into account.

The equivalent thermal networks of the chip or of parts thereof for mutual heating and of the device for self-heating can in general be obtained via different types of modeling that attribute values of thermal resistance and capacity to the structures that make up the devices in the integrated circuit.

According to one embodiment, it is envisaged to use a method of the type that comprises, for evaluation of the thermal effects, generating a layout of the electronic circuit, generating abstract data at the substrate level associated to the layout of the electronic circuit, generating a grid of partitioning, with respect to a view regarding the abstract, into meshes and nodes and applying it to the aforesaid substrate, extracting, on the basis of the partition grid, a thermal netlist regarding the substrate, and making an evaluation of the thermal interactions between devices of the electronic circuit at the substrate level as a function of the thermal netlist regarding the substrate.

It is moreover envisaged to divide the set of the devices of the electronic circuit according to a plurality of vertical layers, separating each of these layers in various regions on the basis of given technological parameters that identify each region in a given layer, and apply the above partition grid to each region of each layer.

It is envisaged, in particular, to identify, in the above view regarding the abstract, on the uppermost layer, i.e., the surface layer, geometrical shapes regarding dissipating structures, and then to apply the partitioning of the area by applying the partition grid to each of these shapes in the view at an abstract level.

The above partitioning is a partitioning obtained via Delaunay triangulation, which hence provides for each structure a partition into triangles. Using Delaunay triangulation the calculation of a dual Voronoi network is then made to identify thereby respective Voronoi nodes. To the aforesaid Voronoi nodes thermal conductances Gt and possibly thermal capacities Ct are associated, as shown in the network 14 of FIG. 2, calculated on the basis of the technological parameters of the layer in question (classified, for example, as semiconductor, insulating, or trench) and of the volume of the associated triangles obtained from the Delaunay triangulation, thus obtaining a square matrix having as row and column index the index of the Voronoi nodes and as elements the conductances connected between the nodes that identify a given row and column.

From this matrix, in a way in itself known, it is possible to extract a corresponding netlist, where the list of the nodes and of the conductances associated to the nodes is indicated.

The above netlist, which may be the combination of netlists obtained layer by layer, in particular by connecting nodes between the layers via thermal conductances that are calculated as a function of the thicknesses of the layers, may hence represent the thermal network 14 of the chip and be connected to the thermal node for the electrothermal simulation coupled with the model or sub-circuit, thus providing the effects of the chip. In a preferred version, from the matrix of conductances, which for example represents the chip, obtained from the operations of Delaunay triangulation and Voronoi mapping, it is possible to obtain reduced thermal networks that represent only the mutual effect of two thermal-dissipation regions, for example two devices, which form part of the chip. The plurality of nodes that make up the aforesaid thermal-dissipation regions is reduced to a respective single node (hence, two nodes in all) and a superposition technique is adopted, applying the dissipation power of each dissipation area separately from the respective node and calculating the equivalent thermal resistance associated to the node and the mutual thermal resistance between the two nodes. In practice, a 2×2 matrix is obtained, the nodes being two, with the equivalent thermal resistances on the diagonal and the mutual resistances on the anti-diagonal. The corresponding netlist, associated to the thermal node of a device or sub-circuit enables an electrothermal simulation that takes into account the interaction with the model or sub-circuit of a given dissipation region, with a calculation that is markedly simplified and enables a fast convergence of the simulator.

Hence, the method and system enable a simulation also of complex sub-circuits to be made via definition of a thermal node in the netlist for definition of the model or sub-circuit that identifies a specific thermal node into which a current equivalent to the power dissipated by the model or sub-circuit is forced, which operates as source for equivalent thermal circuits that represent the chip or the circuits connected to the model or sub-circuit for mutual heating and the equivalent thermal circuit of the model or sub-circuit for self-heating. Instead, the simulator, for example a SPICE-based simulator, is configured for recognizing the voltage on the thermal node as an increase of the local temperature of the device with respect to the global temperature and updates all the model and sub-circuit parameters according to the instantaneous local temperature using the laws of thermal dependence incorporated in the models or written in the sub-circuit or model parameters.

Of course, without prejudice to the principle of the disclosure, the details of construction and the embodiments may vary, even significantly, with respect to what has been illustrated herein purely by way of non-limiting example, without thereby departing from the sphere of protection, this sphere of protection being defined by the annexed claims.

The method for automatic design of an electronic circuit according to the invention may of course be comprised in the process of production of the corresponding electronic circuit, which integrates the design operations, which are associated to the simulation operation, with operations of machining of the integrated circuit, for example in the framework of the so-called “silicon foundry”, i.e., the plant or the part of production line that carries out these machining operations.

What is claimed is:

1. A method, comprising:
obtaining a description of an electronic circuit in terms of list of nodes or netlist suited to operating with a simulator of electronic circuits, in particular a netlist for a simulator of a SPICE type;
performing a simulation, on the basis of said description, the electrical behavior of said electronic circuit and the thermal behavior of said electronic circuit;
wherein performing the simulation comprises:
configuring said simulation for operating with descriptions of models or sub-circuits of said electronic circuit that are defined as comprising a thermal node;
connecting to said thermal node an equivalent current generator that forces into said thermal node a current that is equivalent to or represents the power dissipated in said models or sub-circuits; and
associating to the voltage that is produced on said thermal node an increase in temperature of the models or sub-circuits with respect to a global temperature.

2. The method of claim 1, wherein said electronic circuit comprises one or more electronic devices.

3. The method according to claim 1, further comprising:
connecting thermal networks to said thermal node which represent mutual heating of the electronic circuit and/or self-heating of devices within the electronic circuit; and
simulating thermal effects of said thermal networks using as a source the current forced into the thermal node.

4. The method according to claim 1, further comprising, following associating to the voltage that is produced on said thermal node, updating parameters of the models or sub-circuits according to a local temperature using laws of thermal dependence incorporated in the models or written in the sub-circuit or model parameters.

5. The method according to claim 4, where said local temperature is calculated as the sum of the voltage on the thermal node and of the global temperature.

6. The method according to claim 4, further comprising: obtaining a list of nodes in which to carry out the transient simulation with a step of evaluating the electrical parameters and of the power dissipated, in which said local temperature is considered constant in an elementary time interval in order to treat the thermal variables as decoupled from the electrical parameters.

7. The method according to claim 1, wherein said thermal network representing heating of the electronic circuit is obtained by:
generating a layout of said electronic circuit,
generating abstract data at the substrate level associated to the layout of said electronic circuit,
generating a grid of partition, with respect to a view regarding said abstract, into meshes and nodes, in particular a Delaunay grid, and applying the grid to said substrate,
extracting, on the basis of said partition grid, a thermal netlist regarding the substrate, and
making an evaluation of the thermal interactions between devices of said electronic circuit at the substrate level as a function of said thermal netlist regarding the substrate.

8. The method according to claim 7, further comprising obtaining a matrix of thermal conductances from said partitioning operation having as row index and as column index the nodes obtained from said partitioning operation and as elements the conductances connected between the nodes that identify a given row and column.

9. The method according to claim 8, further comprising: obtaining from said matrix of thermal conductances reduced matrices and netlists accordingly reduced representing the thermal dependence between said device or sub-circuit and a specific source of dissipation in the circuit.

10. A system for automatic design of an electronic circuit, comprising at least one computer configured for executing computer program code which performs the steps of:
obtaining a description of an electronic circuit in terms of list of nodes or netlist suited to operating with a simulator of electronic circuits, in particular a netlist for a simulator of a SPICE type;
performing a simulation, on the basis of said description, the electrical behavior of said electronic circuit and the thermal behavior of said electronic circuit;
wherein performing the simulation comprises:
configuring said simulation for operating with descriptions of models or sub-circuits of said electronic circuit that are defined as comprising a thermal node;
connecting to said thermal node an equivalent current generator that forces into said thermal node a current that is equivalent to or represents the power dissipated in said models or sub-circuits; and
associating to the voltage that is produced on said thermal node an increase in temperature of the models or sub-circuits with respect to a global temperature.

11. A non-transitory computer storage medium having stored thereon computer program code that, when executed by a processor, performs the steps of:
obtaining a description of an electronic circuit in terms of list of nodes or netlist suited to operating with a simulator of electronic circuits, in particular a netlist for a simulator of a SPICE type;
performing a simulation, on the basis of said description, the electrical behavior of said electronic circuit and the thermal behavior of said electronic circuit;
wherein performing the simulation comprises:
configuring said simulation for operating with descriptions of models or sub-circuits of said electronic circuit that are defined as comprising a thermal node;
connecting to said thermal node an equivalent current generator that forces into said thermal node a current that is equivalent to or represents the power dissipated in said models or sub-circuits; and
associating to the voltage that is produced on said thermal node an increase in temperature of the models or sub-circuits with respect to a global temperature.
